(19) United States
(12) Patent Application Publication
(10) Pub. No.: US 2015/0295642 A1
(43) Pub. Date: Oct. 15, 2015

(54) OPTICAL ACTIVE CABLE AND OPTICAL TRANSMISSION SYSTEM

(71) Applicant: Hitachi Metals, Ltd., Tokyo (JP)

(72) Inventors: Masayuki NIKAIDO, Hitachi (JP); Hiroki KATAYAMA, Hitachi (JP); Yuki NAGANUMA, Hitachi (JP)

(73) Assignee: Hitachi Metals, Ltd., Tokyo (JP)

(21) Appl. No.: 14/291,599

(22) Filed: May 30, 2014

(30) Foreign Application Priority Data
Jun. 25, 2013 (JP) 2013-132476

(51) Int. Cl. H04B 10/079; H04B 10/25; H04B 10/50

(52) U.S. Cl. CPC H04B 10/0795; H04B 10/50; H04B 10/2504

(57) ABSTRACT

An optical active cable includes an optical cable, optical modules disposed at both ends of the optical cable and each including a transmission part including a light emitting element and a reception part including a light receiving element, a light intensity detection part disposed in each of the optical modules to detect an intensity of a light received by the light receiving element, a communication means to transmit and receive a data of the light intensity detected by the light intensity detection part between the optical modules, and a light intensity transmission reception part disposed in each of the optical modules to transmit the data of the light intensity detected by the light intensity detection part to an opposite one of the optical modules via the communication means, and to receive the data of the light intensity transmitted from an opposite one of the optical modules via the communication means.

The present application is based on Japanese patent application No. 2013-132476 filed on Jun. 25, 2013, the entire contents of which are incorporated herein by reference.

### BACKGROUND OF THE INVENTION

1. Field of the Invention

This invention relates to an optical active cable and an optical transmission system using the optical active cable.

2. Description of the Related Art

An optical active cable is known that includes an optical cable and optical modules disposed at both ends of the optical cable, wherein the optical modules each include a transmission part having a light emitting element and configured to convert an electrical signal to an optical signal and a reception part having a light receiving element and configured to convert an optical signal to an electrical signal.

The light emitting element mounted in the optical module of the optical active cable is e.g. a vertical cavity surface emitting laser (VCSEL). The light receiving element mounted in the optical module of the optical active cable is e.g. a photo diode (PD).

In the optical active cables, the light intensity (or light power) obtained from the light emitting element may be reduced due to the aging even when the drive current does not change. If the light intensity is considerably reduced, the optical communications may malfunction. Thus it is desired to make e.g. a countermeasure in which the light intensity obtained from the light emitting element is monitored and if the light intensity is reduced, the light intensity is kept at a desired intensity by increasing the drive current.

When VCSEL is used as the light emitting element, a method of monitoring the intensity of a light branched from a forward output light by a half mirror or the like is generally used since VCSEL has no backward output light.

JP-A-2005-099510 has proposed a method of monitoring the light intensity from the light emitting element, in which a light receiving element for monitoring is disposed in the transmission-side optical module such that the light receiving element can monitor a reflection light reflected by an incident end surface of an optical fiber located so as to face the light emitting element.

### SUMMARY OF THE INVENTION

In the conventional method, where the light receiving element for monitoring is disposed in the optical module, there is a problem that the optical module may be complicated in structure and may increase in size.

It is an object of the invention to provide an optical active cable that can monitor the light intensity of a light emitted from a light emitting element without complicating the structure of optical module, as well as an optical transmission system using the optical cable.

(1) According to one embodiment of the invention, an optical active cable comprises:

an optical cable;

optical modules disposed at both ends of the optical cable and each comprising a transmission part comprising a light emitting element and configured to convert an electrical signal to an optical signal and a reception part comprising a light receiving element and configured to convert an optical signal to an electrical signal;

a light intensity detection part disposed in each of the optical modules and configured to detect an intensity of a light received by the light receiving element of the reception part;

a communication means configured to transmit and receive a data of the light intensity detected by the light intensity detection part between the optical modules; and

a light intensity transmission reception part disposed in each of the optical modules and configured to transmit the data of the light intensity detected by the light intensity detection part to an opposite one of the optical modules via the communication means, and to receive the data of the light intensity transmitted from an opposite one of the optical modules via the communication means.

In the above embodiment (1) of the invention, the following modifications and changes can be made.

(i) The optical active cable further comprises a light intensity control part disposed in each of the optical modules and configured to control a light intensity of the light emitting element of the transmission part based on the data of the light intensity received from the opposite one of the optical modules.

(ii) The light emitting element comprises an arrayed light emitting element with a plurality of light emitting parts,

wherein the light receiving element comprises an arrayed light receiving element with a plurality of light receiving parts,

wherein the optical cable comprises a plurality of optical fibers each corresponding to the plurality of light emitting parts and the light receiving parts so as to enable communication through a plurality of channels, and

wherein the communication means comprises one of the plurality of channels so as to transmit and receive the data of the light intensity as an optical signal.

(iii) The communication means is configured to superpose the data of the light intensity on normal data to be transmitted and received via the optical cable so as to transmit and receive the superposed data.

(iv) The communication means comprises an electric wire configured to connect the optical modules so as to transmit and receive the data of the light intensity by an electric signal.

(v) The communication means comprises a radio communication device mounted on the optical modules so as to transmit and receive the data of the light intensity by radio waves.

(2) According to another embodiment of the invention, an optical transmission system comprises:

the optical active cable according to the above embodiment (1); and

two communication devices connected to each other by the optical active cable so as to be mutually communicated via the optical active cable.

### EFFECTS OF THE INVENTION

According to one embodiment of the invention, an optical active cable can be provided that can monitor the light intensity of a light emitted from a light emitting element without complicating the structure of optical module, as well as an optical transmission system using the optical cable.

### BRIEF DESCRIPTION OF THE DRAWINGS

The preferred embodiments according to the invention will be explained below referring to the drawings, wherein:

FIG. 1 is a block diagram schematically showing an optical active cable according to one embodiment of the invention;

FIG. 2 is a block diagram schematically showing an optical active cable according to the other embodiment of the invention;

FIG. 3 is a block diagram schematically showing an optical active cable according to the other embodiment of the invention; and

FIG. 4 is a block diagram schematically showing an optical active cable according to the other embodiment of the invention.

### DETAILED DESCRIPTION OF THE PREFERRED EMBODIMENTS

Hereinafter, the embodiments according to the invention will be explained in accordance with the accompanying drawings.

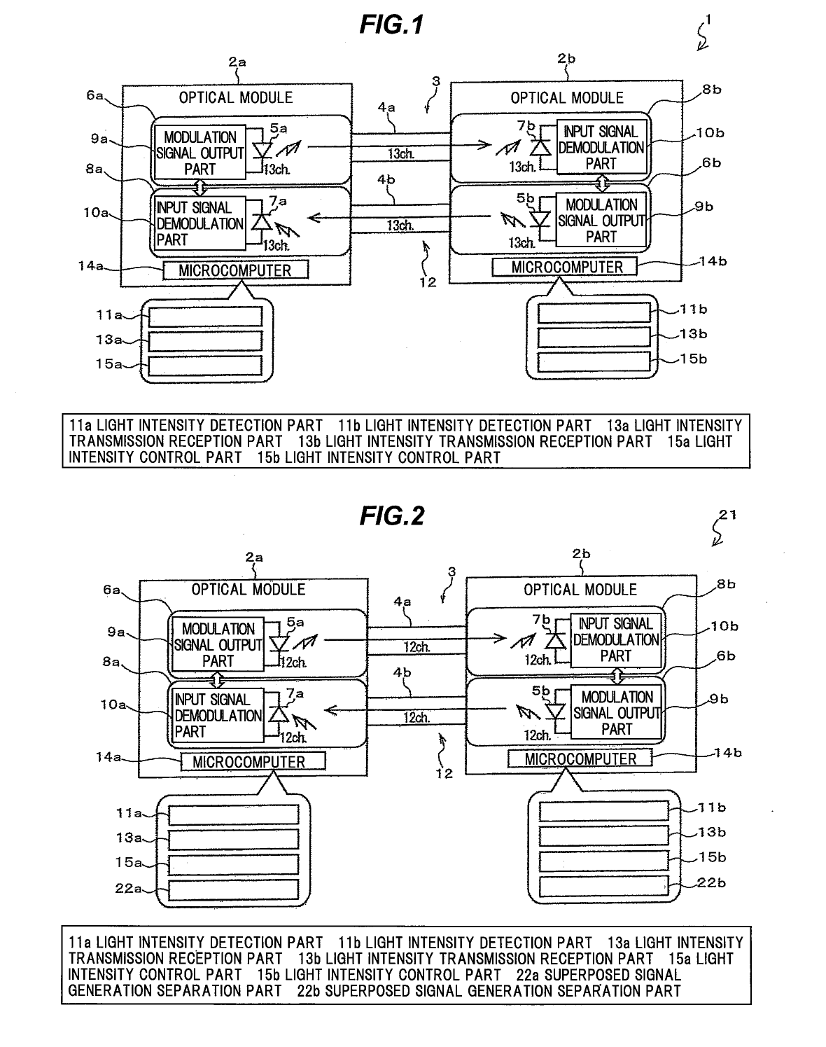

FIG. 1 is a block diagram schematically showing an optical active cable according to one embodiment of the invention.

As shown in FIG. 1, the optical active cable 1 includes an optical cable 3 and an optical module 2a, 2b configured to be disposed in both of end parts of the optical cable 3 respectively.

The optical module 2a, 2b is configured to include a transmission part 6a, 6b configured to have a light emitting element 5a, 5b and convert an electrical signal to an optical signal and a reception part 8a, 8b configured to have a light receiving element 7a, 7b and convert an optical signal to an electrical signal.

The optical cable 3 has a transmission side optical fiber 4a and a reception side optical fiber 4b and is configured such that the transmission part 6a of the optical module 2a and the reception part 8b of the optical module 2b are connected to each other via the transmission side optical fiber 4a, and the transmission part 6b of the optical module 2b and the reception part 8a of the optical module 2a are connected to each other via the reception side optical fiber 4b, so that both of the optical modules 2a, 2b can be communicated with each other via the transmission side optical fiber 4a and the reception side optical fiber 4b.

In the optical active cable 1, an electrical signal input to the optical module 2a is modulated by a modulation signal output part 9a mounted in the transmission part 6a of the optical module 2a and is converted to an optical signal at the light emitting element 5a so as to be output to the transmission side optical fiber 4a. The optical signal passing through the transmission side optical fiber 4a is input to the reception part 8b of the optical module 2b, is received by the light receiving element 7b and converted to an electrical signal, and is demodulated by an input signal demodulation part 10b mounted in the reception part 8b so as to be output to the outside.

Similarly, an electrical signal input to the optical module 2b is modulated by a modulation signal output part 9b mounted in the transmission part 6b of the optical module 2b and is converted to an optical signal at the light emitting element 5b so as to be output to the transmission side optical fiber 4b. The optical signal passing through the transmission side optical fiber 4b is input to the reception part 8a of the optical module 2a, is received by the light receiving element 7a and converted to an electrical signal, and is demodulated by an input signal demodulation part 10a mounted in the reception part 8a so as to be output to the outside.

In the embodiment, an array-like shaped light emitting element having a plurality of light emitting parts as the light emitting element 5a, 5b is used and simultaneously an array-like shaped light receiving element having a plurality of light receiving parts as the light receiving element 7a, 7b is used, and as the optical cable 3, an optical cable having a plurality of optical fibers 4a, 4b corresponding to the plurality of light emitting parts and the plurality of light receiving parts is used, thereby the optical active cable 1 is configured to be capable of being communicated through a plurality of channels. Here, as the light emitting element 5a, 5b, a VCSEL array is used and as the light receiving element 7a, 7b, a PD array is used.

Then, the optical active cable 1 according to the embodiment includes a light intensity detection part 11a, 11b configured to be mounted in both of the optical modules 2a, 2b respectively and detect a light intensity of a light received by the light receiving element 7a, 7b of the reception part 8a, 8b, a communication means 12 configured to transmit and receive the data of the light intensity detected by the light intensity detection part 11a, 11b between both of the optical modules 2a, 2b, and a light intensity transmission reception part 13a, 13b configured to be mounted in both of the optical modules 2a, 2b respectively and transmit the data of the light intensity detected by the light intensity detection part 11a, 11b to the optical module 2b, 2a of the opposite party via the communication means 12, and simultaneously receive the data of the light intensity transmitted from the optical module 2b, 2a of the opposite party via the communication means 12.

The light intensity detection part 11a, 11b and the light intensity transmission reception part 13a, 13b are incorporated into a microcomputer 14a, 14b disposed in the optical module 2a, 2b and are realized by appropriately combining a CPU, a software, a memory, an interface and the like with each other.

The light intensity of a light received by the light receiving element 7a becomes a light intensity according to the light intensity of a light emitted from the light emitting element 5b. Consequently, the light intensity of a light received by the light receiving element 7a is detected by the light intensity detection part 11a, and this is transmitted to the light intensity transmission reception part 13b by the light intensity transmission reception part 13a via the communication means 12, thereby in the optical module 2b, the light intensity of the light emitting element 5b of the transmission part 6b mounted in itself can be monitored.

Similarly, the light intensity of a light received by the light receiving element 7b becomes a light intensity according to the light intensity of a light emitted from the light emitting element 5a. Consequently, the light intensity of a light received by the light receiving element 7b is detected by the light intensity detection part 11b, and this is transmitted to the light intensity transmission reception part 13a by the light intensity transmission reception part 13b via the communication means 12, thereby in the optical module 2a, the light intensity of the light emitting element 5a of the transmission part 6a mounted in itself can be monitored.

Thus, it becomes possible that in the optical module 2a, 2b, the light intensity of the light emitting element 5a, 5b of the transmission part 6a, 6b mounted in itself is monitored in real time, and a light emitted from the light emitting element 5a, 5b is controlled to be a desired light intensity.

The optical active cable 1 according to the embodiment further includes a light intensity control part 15a, 15b configured to be mounted in both of the optical modules 2a, 2b respectively and control the light intensity of the light emitting element 5a, 5b of the transmission part 6a, 6b mounted in itself based on the data of the light intensity received from the optical module 2b, 2a of the opposite party.

The light intensity control part 15a, 15b is configured to, for example, to actively control the driving current of the light emitting element 5a, 5b so that the light emitted from the light emitting element 5a, 5b becomes a desired light intensity based on the data of the light intensity received from the optical module 2b, 2a of the opposite party.

As the data of the light intensity transmitted and received between both of the light intensity transmission reception parts 13a, 13b, the output current value of the light receiving element 7a, 7b can be used as it is, and the value of the light intensity calculated from the output current value can be also used.

In addition, in the embodiment, an VCSEL array is used as the light emitting element 5a, 5b, and a PD array is used as the light receiving element 7a, 7b, thereby communication is capable of being performed in a plurality of channels, in this case, as the data of the light intensity transmitted and received between both of the light intensity transmission reception parts 13a, 13b, the data of the light intensity of all the channels can be transmitted and received, and the data of the light intensity of the only one representative channel can be also transmitted and received. In the case that the data of the light intensity of all the channels are transmitted and received, it becomes possible to configure the light intensity control part 15a, 15b to individually control the driving current of each channel so as to individually control the light intensity of each channel.

In addition, in the embodiment, the communication means 12 is configured to transmit and receive the data of the light intensity by using one channel of a plurality of the channels by an optical signal.

For example, in the case that 12 channels are used in usual communication, the channel number is set to not less than 13 channels, thereby one channel can be uses as a channel for transmitting and receiving the data of the light intensity, namely the communication means 12.

Further, the channel used as the communication means 12 can be also used as a backup channel when the channels for usual communication are in failure. In this case, it is needed for the optical module 2a, 2b to include a switching means configured to switch to the backup channel when the channels are in failure.

The optical transmission system can be obtained by being configured such that two communication devices are connected to each other by using the optical active cable 1 according to the embodiment so as to be capable of being mutually communicated between the two communication devices via the optical active cable 1.

As explained above, the optical active cable 1 according to the embodiment includes the light intensity detection part 11a, 11b configured to be mounted in both of the optical modules 2a, 2b respectively and detect a light intensity of a light received by the light receiving element 7a, 7b of the reception part 8a, 8b, the communication means 12 configured to transmit and receive the data of the light intensity detected by the light intensity detection part 11a, 11b between both of the optical modules 2a, 2b, and the light intensity transmission reception part 13a, 13b configured to be mounted in both of the optical modules 2a, 2b respectively and transmit the data of the light intensity detected by the light intensity detection part 11a, 11b to the optical module 2b, 2a of the opposite party via the communication means 12, and simultaneously receive the data of the light intensity transmitted from the optical module 2b, 2a of the opposite party via the communication means 12.

Namely, the optical active cable 1 is configured to monitor the light intensity of the light emitting element 5a, 5b by the light receiving element 7a, 7b mounted in the optical module 2b, 2a on the receiving side, instead of directly monitoring by the optical module 2a, 2b on the transmitting side, and to return the data of the light intensity monitored to the optical module 2a, 2b on the transmitting side.

with such a configuration, even if a receiving element for monitoring is not mounted in the optical module 2a, 2b, it becomes possible to monitor the light intensity of the light emitted from the light emitting element 5a, 5b of the transmission part 6a, 6b by the optical module 2a, 2b, the light emitting element 5a, 5b being mounted in itself.

Namely, according to the optical active cable 1, it becomes possible to monitor the light intensity of the light emitted from the light emitting element 5a, 5b without complicating the structure of the optical module 2a, 2b. In addition, in the optical active cable 1, it becomes possible to reduce the optical module 2a, 2b in size and to enhance the freedom of mounting in comparison with a configuration that the receiving element for monitoring is mounted.

In addition, in the embodiment, the communication means 12 is configured to transmit and receive the data of the light intensity by using one channel of a plurality of channels by an optical signal, so that it can be realized with a simple configuration and can be lower in cost.

Next, the other embodiments of the invention will be explained.

The optical active cable 21 shown in FIG. 2 has basically the same configuration as the optical active cable 1 shown in FIG. 1, but it is different in a configuration of the communication means 12.

In the optical active cable 21, the communication means 12 is configured to superpose the data of the light intensity on normal data to be transmitted and received via the optical cable 3 so as to transmit and receive the superposed data. In both of the optical modules 2a, 2b, a superposed signal generation separation part 22a, 22b is mounted that is configured to generate a signal in which the data of the light intensity are superposed on the normal data so as to output to the transmission part 6a, 6b and simultaneously to separate the superposed signal received by the reception part 8a, 8b into the normal data and the data of the light intensity.

In addition, the optical active cable 1 is configured such that as the data of the light intensity transmitted and received between both of the light intensity transmission reception part 13a, 13b, the output current value of the light receiving element 7a, 7b or the value of the light intensity calculated from the output current value is used, but the optical active cable 21 is configured such that the light intensity detection part 11a, 11b judges whether the output current value of the light receiving element 7a, 7b is lower than a preset threshold or not, and if the value is lower than the threshold, the light intensity detection part 11a, 11b transmits and receives a signal showing the above-mentioned fact as the data of the light intensity.

More specifically, in the optical active cable 21, the light intensity detection part 11a, 11b is configured such that a threshold to the light intensity (output current value) detected by light receiving element 7a, 7b is set therein, and if the light intensity is lower than the threshold, the light intensity detection part 11a, 11b changes the condition of a specific resistor in a memory (ROM) (not shown) so as to record the deterioration of the light intensity. As the threshold, a value (for example, a value of 50% of the initial light intensity) or the like can be used, the value being obtained, for example, by recording the initial light intensity in a memory by the light intensity detection part 11a, 11b and reducing from the initial light intensity at a predetermined ratio.

The light intensity transmission reception part 13a, 13b is configured to transmit a signal showing the fact that the light intensity detected by the light intensity detection part 11a, 11b is lower than the threshold to the optical modules 2b, 2a of the opposite party as the data of the light intensity, if the condition of the above-mentioned specific resistor is changed. At this time, by the superposed signal generation separation part 22a, 22b, a specific modulation signal is generated and an interposition signal is generated, so that the signals are transmitted as an optical signal to the optical modules 2b, 2a of the opposite party.

In the optical modules 2b, 2a of the opposite party that receives the signal showing the fact that the light intensity detected by the light intensity detection part 11a, 11b is lower than the threshold, the fact that the signal is received is recorded in the specific resistor in the memory (ROM), and simultaneously, in the light intensity control part 15a, 15b, for example, such a control that gradually raises the driving current is carried out until the signal showing the fact of being lower than the threshold is not received.

The optical active cable 21 is configured to superpose the data of the light intensity on normal data so as to transmit and receive the superposed data, thus it is not needed that a channel for transmitting and receiving the data of the light intensity is separately included. Consequently, one that has a minimum required channel number may be used, thus it becomes possible to be further reduce the cost.

In addition, the optical active cable 21 is configured such that the light intensity detection part 11a, 11b judges whether the output current value of the light receiving element 7a, 7b is lower than a preset threshold or not, and if the value is lower than the threshold, the light intensity detection part 11a, 11b transmits and receives a signal showing the above-mentioned fact as the data of the light intensity, thus the data of the light intensity are transmitted only at the time of the deterioration of the light emitting element 5a, 5b being generated so that it becomes possible to suppress a communication volume between both of the optical modules 2a, 2b.

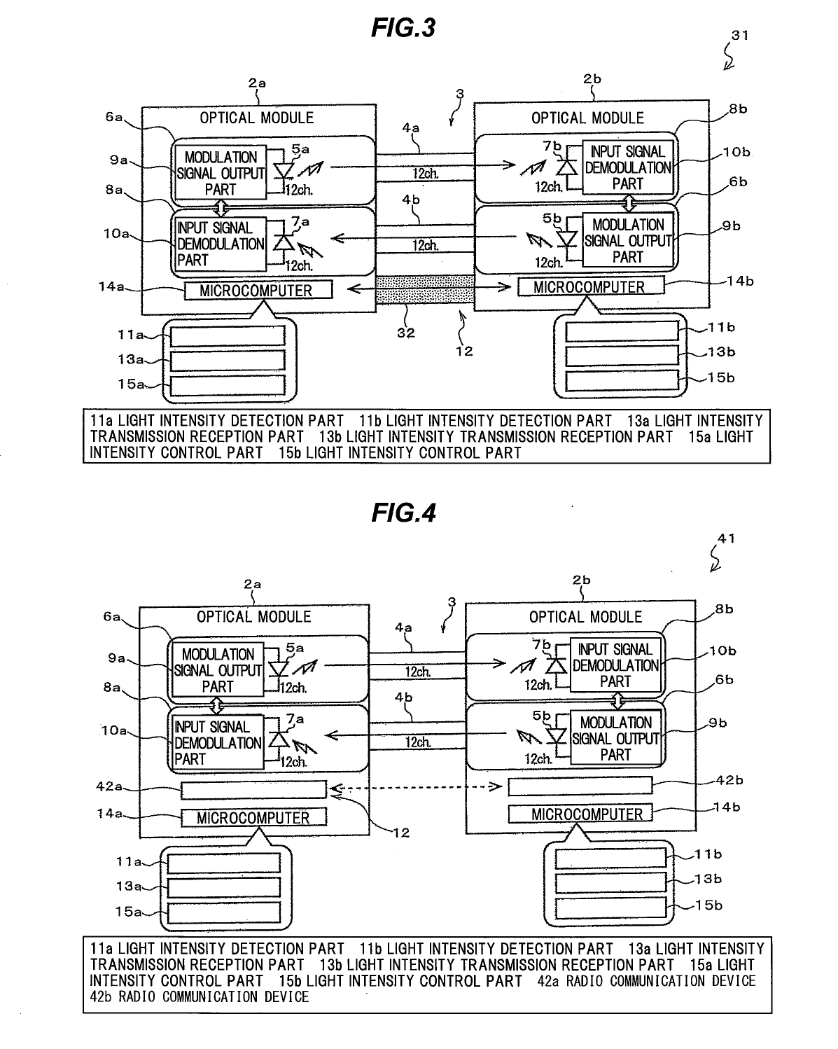

The optical active cable 31 shown in FIG. 3 is configured such that the communication means 12 is comprised of an electrical wire (a metal cable) 32 that connects the two optical modules 2a, 2b to each other. The light intensity transmission reception part 13a, 13b is configured to transmit and receive the data of the light intensity by an electrical signal. Further, a configuration can be adopted that as the optical cable 3, an optoelectric composite cable obtained by compositing the electric wire is used and the composite cable is used as the communication means 12. In addition, the electrical signal used when the data of the light intensity are transmitted and received can be an analogue signal and can be also a digital signal.

The optical active cable 41 shown in FIG. 4 is configured such that the communication means 12 is comprised of a radio communication device 42a, 42b mounted in the two optical modules 2a, 2b respectively. The light intensity transmission reception part 13a, 13b is configured to transmit and receive the data of the light intensity by radio waves.

Although the invention has been described with respect to the specific embodiments for complete and clear disclosure, the appended claims are not to be thus limited but are to be construed as embodying all modifications and alternative constructions that may occur to one skilled in the art which fairly fall within the basic teaching herein set forth.

For example, although not mentioned in the above-explained embodiments, in the case that the light intensity of the light emitting element 5a, 5b is not raised even if the driving current is raised by the light intensity control part 15a, 15b, it is considered that a failure such that a breakage of the optical cable 3 is generated. Consequently, a failure judgment part can be further included that judges as the generation of failure if the driving current is higher than the preset upper limit threshold and the value of the light intensity received from the optical module 2b, 2a of the opposite party is lower than the preset threshold.

What is claimed is:

1. An optical active cable, comprising:
an optical cable;
optical modules disposed at both ends of the optical cable and each comprising a transmission part comprising a light emitting element and configured to convert an electrical signal to an optical signal and a reception part comprising a light receiving element and configured to convert an optical signal to an electrical signal;
a light intensity detection part disposed in each of the optical modules and configured to detect an intensity of a light received by the light receiving element of the reception part;
a communication means configured to transmit and receive a data of the light intensity detected by the light intensity detection part between the optical modules; and
a light intensity transmission reception part disposed in each of the optical modules and configured to transmit the data of the light intensity detected by the light intensity detection part to an opposite one of the optical modules via the communication means, and to receive the data of the light intensity transmitted from an opposite one of the optical modules via the communication means.

2. The optical active cable according to claim 1, further comprising a light intensity control part disposed in each of the optical modules and configured to control a light intensity of the light emitting element of the transmission part based on the data of the light intensity received from the opposite one of the optical modules.

3. The optical active cable according to claim 1, wherein the light emitting element comprises an arrayed light emitting element with a plurality of light emitting parts,
wherein the light receiving element comprises an arrayed light receiving element with a plurality of light receiving parts,
wherein the optical cable comprises a plurality of optical fibers each corresponding to the plurality of light emitting parts and the light receiving parts so as to enable communication through a plurality of channels, and
wherein the communication means comprises one of the plurality of channels so as to transmit and receive the data of the light intensity as an optical signal.

4. The optical active cable according to claim 1, wherein the communication means is configured to superpose the data of the light intensity on normal data to be transmitted and received via the optical cable so as to transmit and receive the superposed data.

5. The optical active cable according to claim 1, wherein the communication means comprises an electric wire configured to connect the optical modules so as to transmit and receive the data of the light intensity by an electric signal.

6. The optical active cable according to claim 1, wherein the communication means comprises a radio communication device mounted on the optical modules so as to transmit and receive the data of the light intensity by radio waves.

7. An optical transmission system, comprising:
the optical active cable according to claim 1; and
two communication devices connected to each other by the optical active cable so as to be mutually communicated via the optical active cable.
